(19) United States
(12) Patent Application Publication
(10) Pub. No.: US 2005/0071529 A1
(43) Pub. Date: Mar. 31, 2005

(54) Counting semaphores for network processing engines

(75) Inventors: Daniel G. Borkowski, Lunenburg, MA (US); Nancy S. Borkowski, Lunenburg, MA (US)

Correspondence Address: Jung-Hua Kuo Attorney at Law;c/o PortfolioIP, P.O. Box 52050, Minneapolis, MN, 55402, US

(73) Assignee: Intel Corporation, a Delaware Corporation, Santa Clara, CA (US)

(21) Appl. No.: 10/675,882

(22) Filed: Sep. 30, 2003

(51) Int. Cl. G06F 3/00

(52) U.S. Cl. 710/52

(57) ABSTRACT

Systems and methods are disclosed for implementing software FIFOs on network processing engines (NPEs). The logic needed to support these software FIFOs is believed to be less than that needed to support additional hardware FIFOs, especially as the number of additional FIFOs is increased. Thus, the systems and methods enable NPEs to utilize more FIFOs at less cost. The counting semaphores that are used in the implementation of the software FIFOs can also, or alternatively, be used to provide NPEs with additional resource-locking and signaling functionality.

### BACKGROUND

Network Processing Engines (NPEs) typically contain hardware support for a relatively limited number of first-in-first-out (FIFO) memories. It is often the case, however, that the software running on NPEs could benefit from more FIFOs.

While it is possible to implement additional FIFOs in software, there are problems with this approach. A FIFO typically has separate reader and writer contexts, and a software FIFO typically must maintain a read pointer and a write pointer. However, it is generally infeasible to maintain an explicit count of the amount of data in each FIFO because the count must be written by both the reader after reading data, and the writer after writing data, which creates problems if the reader and writer are running at different priorities, as is often the case, and one is interrupted by the other. Such a count would be useful, however, since the reader typically must check whether the FIFO is empty before reading from it, and the writer typically must check whether the FIFO is full before writing to it. Without an explicit count, the reader and writer will generally need to compare the read and write pointers to determine the empty/full status of the FIFO, and this comparison can consume several cycles of execution time. Moreover, even if it is determined that the read and write pointers are equal, this can indicate either that the FIFO is full or that it is empty, so additional processing is generally needed to make the correct determination, which further degrades performance.

### BRIEF DESCRIPTION OF THE DRAWINGS

In the accompanying drawings, like reference numerals designate like structural elements.

FIG. 1 illustrates the operation of a counting semaphore in accordance with one embodiment.

FIG. 2 is a flow chart of a method for incrementing a counting semaphore.

FIG. 3 is a flow chart of a method for decrementing a counting semaphore.

FIG. 4 shows an illustrative implementation of the functionality shown in FIGS. 2 and 3.

FIGS. 5A, 5B, 5C, and 5D illustrate a conventional FIFO memory.

FIG. 6 illustrates a method for writing data to a FIFO in accordance with one embodiment.

FIG. 7 illustrates a method for reading data from a FIFO in accordance with one embodiment.

FIG. 8 illustrates a network processing engine.

### DESCRIPTION OF SPECIFIC EMBODIMENTS

Systems and methods are disclosed for using counting semaphores in network processing engines. The counting semaphores can be used to implement software FIFOs and/or to provide other functionality. For example, counting semaphores can be implemented in network processing engines to provide support for software FIFOs. The logic needed to support these FIFOs is believed to be less than that needed to support additional hardware FIFOs, especially as the number of additional FIFOs is increased. Thus, embodiments described herein enable network processing engines to utilize more FIFOs at less cost. The counting semaphores that are used in the embodiment can also, or alternatively, be used to provide NPEs with additional resource-locking and signaling functionality.

It should be appreciated that the concepts and methodologies presented herein can be implemented in numerous ways, including as a process, an apparatus, a system, a device, a method, or a computer readable medium such as a computer readable storage medium or a computer network wherein program instructions are sent over optical or electronic communication lines. Several inventive embodiments are described below.

In one embodiment, a method is provided for implementing a software FIFO in a network processing engine. When a request to write data to a FIFO is received, the value of a counting semaphore is compared with a predefined maximum value in order to determine whether the FIFO is full. If the value of the counting semaphore is less than the predefined maximum value, the counting semaphore is incremented, and the data is written to the FIFO. If a request to read data from the FIFO is received, the value of the counting semaphore is compared with a predefined minimum value in order to determine whether the FIFO is empty. If the value of the counting semaphore is greater than the predefined minimum value, then the counting semaphore is decremented and data is read from the FIFO.

In another embodiment, a network processing engine is provided. The network processing engine contains one or more coprocessors, memory, a counting semaphore, signaling logic for signaling the status of a FIFO, and computer code operable to implement a FIFO using the counting semaphore and the signal generation logic. In one embodiment, the signal generation logic is operable to generate a signal indicating whether or not the FIFO is full or empty, and whether the FIFO contains more than a first predefined amount of data or less than a second predefined amount of data.

In yet another embodiment, a method for implementing a software FIFO in a network processing engine is provided that makes use of a counting semaphore to maintain a count of the amount of data in the FIFO.

In yet another embodiment, a signaling method is provided that is suitable for performance by a network processing engine. A counting semaphore is maintained, the value of which can be atomically incremented and decremented. The semaphore can be incremented in response to a first action taken by a first process—such as writing data to a FIFO—and a second process can take a second action based on the value of the semaphore—such as reading data from the FIFO. In some embodiments, additional signaling functionality can be provided by a set of flags, which may, for example, be set to indicate that a FIFO is full, empty, almost full, almost empty, and/or the like.

These and other features and advantages will be presented in more detail in the following detailed description and the accompanying figures which illustrate by way of example the principles presented herein. The following description is presented to enable any person skilled in the art to make and use the inventive body of work. Descriptions of specific embodiments and applications are provided only as examples and various modifications will be readily apparent to those skilled in the art. The general principles defined herein may be applied to other embodiments and applications. For example, while several embodiments are described in the context of network processing engines, it will be appreciated that the systems and methods described herein could be implemented in other contexts as well. Thus, the concepts and methodologies presented herein are to be accorded the widest scope, encompassing numerous alternatives, modifications, and equivalents consistent with the principles and features disclosed herein. For purpose of clarity, details relating to technical material that is known in the related fields have not been described in detail so as not to unnecessarily obscure the concepts and methodologies presented herein.

A Network Processing Engine (NPE) often contains numerous coprocessors that each perform specialized functions to assist the NPE firmware in data processing. For example, NPEs such as those contained in the IXP425, manufactured by Intel Corporation of Santa Clara, Calif., include a condition coprocessor that contains, among other features, a set of mutually exclusive (mutex) semaphores. These semaphores provide a simple and efficient mechanism for controlling access to a resource (sometimes referred to as resource locking), as well as signaling between NPE software contexts or threads.

Each mutex semaphore consists of a single bit, whose state can be one of two values: set or clear. The mutex semaphore hardware supports two basic operations for each mutex: TestAndSet and TestAndClear. Each of these operations is atomic, meaning that it cannot be interrupted by other operations (e.g., is executed in a single cycle). Thus, a context can effectively read-and-set a mutex or read-and-clear a mutex without concern for being preempted in the middle by a higher-priority context. In addition, the state (set or clear) can be wired to signal other contexts. For example, a context could “wake up” when a particular mutex is set or cleared.

Conventional mutex semaphores are often used to protect the use of a resource or to coordinate the execution of critical code sections in multi-threaded environments. For example, each thread may wish to modify the value of a shared variable or to make use of the same resource, and thus it might be important to ensure that only one thread can execute its critical section at a time. There are a variety of ways to implement mutex semaphores to ensure their atomicity, including in hardware (e.g., using a J-K flip flop) and/or in software (e.g., by disabling interrupts to ensure that only one process can modify the semaphore at a time).

Embodiments described herein extend the conventional mutex semaphore functionality. The one-bit state of the mutex semaphores is replaced with an N-bit count, where N is an arbitrary number greater than 1. The TestAndSet and TestAndClear operations are replaced with ReadAndIncrement and ReadAndDecrement operations. These two operations may be atomic, depending on the specific implementation in hardware.

The ReadAndIncrement operation performs a read of the semaphore count, and then increments the count by one. The ReadAndDecrement operation performs a read of the semaphore count, and then decrements the count by one. If N equals 1, the counting semaphore functionality is basically equivalent to the mutex semaphore functionality described above.

In various embodiments, further signaling and condition functionality is provided by the addition of three predefined, configuration values: Maximum Value, High Watermark, and Low Watermark. Each of these values may be sized similarly to the semaphore count (e.g., N bits). These configuration values can be used in conjunction with the semaphore count to generate four single-bit condition signals: Empty, Nearly Empty, Nearly Full, and Full. In one embodiment, these signals are defined as follows:

Empty is asserted when the semaphore count equals zero.

Nearly Empty is asserted when the semaphore count is less-than or equal-to the value of the Low Watermark.

Nearly Full is asserted when the semaphore count is greater-than or equal-to the value of the High Watermark.

Full is asserted when the semaphore count equals Maximum Value.

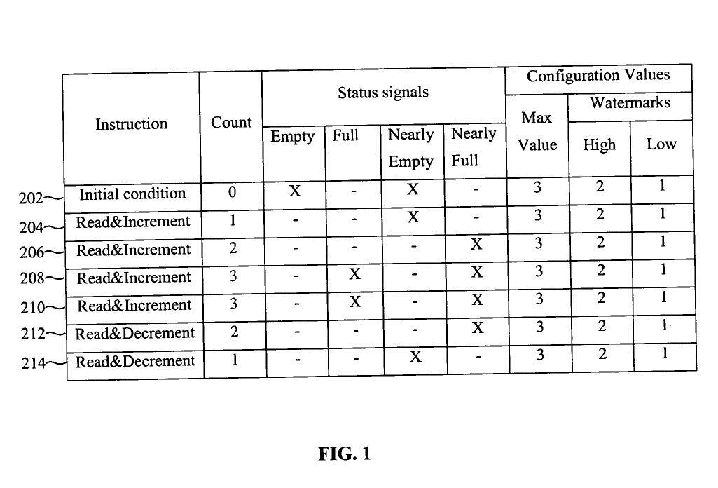

FIG. 1 shows a counting semaphore in action. In this example, the maximum value of the semaphore count is 3, and high and low watermarks are set at 2 and 1, respectively. The count is initially set to 0 in row 202, and the Empty and Nearly Empty flags are set. When a ReadAndIncrement operation is performed in row 204, the value of the semaphore count increases from 0 to 1, and the Empty flag is cleared. When another ReadAndIncrement operation is performed in row 206, the semaphore count increases from 1 to 2. Since 2 is greater than the value of the low watermark, the Nearly Empty flag is cleared; however, since the value of the high watermark is 2, the Nearly Full flag is set. When the semaphore count is incremented again at row 208, it reaches its maximum value and the Full signal is asserted. As shown in rows 212 and 214, a similar process occurs when successive ReadAndDecrement operations are performed to return the count to 1.

In one embodiment, the ReadAndDecrement operation performs no function if the semaphore count equals zero prior to the decrement operation, thereby ensuring that the count never drops below zero. Likewise, the ReadAndIncrement operation optionally performs no function if the semaphore count equals Maximum Value, thereby ensuring that the count never exceeds that value. This is illustrated in row 210 of FIG. 1, where execution of ReadAndIncrement when the value of count equals 3 (i.e., its maximum value) results in no further increase in the count.

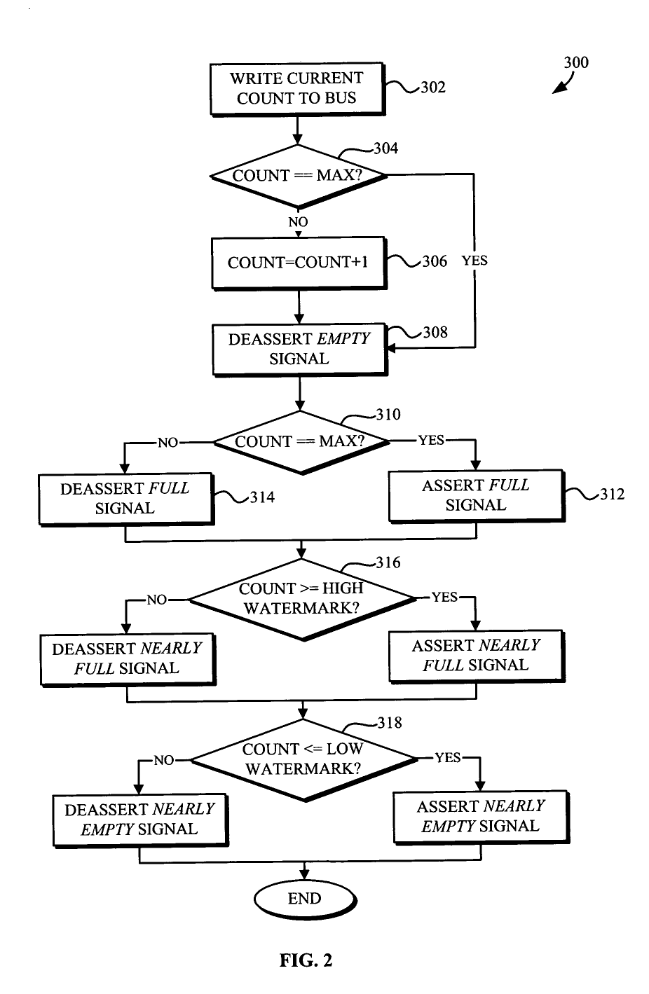

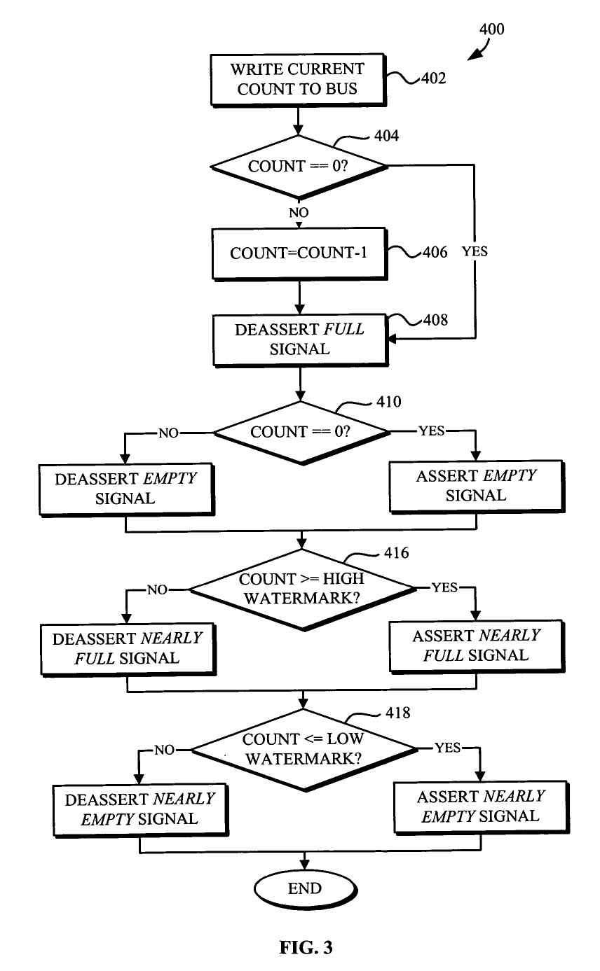

FIGS. 2 and 3 show illustrative implementations of the ReadAndIncrement and ReadAndDecrement operations, respectively. Referring to FIG. 2, the ReadAndIncrement operation 300 begins by examining the current value of the semaphore count (blocks 302 and 304). If the count is already at its maximum value (i.e., a “Yes” exit at block 304), it is incremented no further. However, if the count is not at its maximum value (i.e., a “No” exit at block 304), it is incremented at block 306. In either case, the Empty signal is deasserted (block 308), and the (potentially updated) value of the count is compared once again to the predefined maximum value (block 310). If the count is equal to its maximum value, then the Full signal is asserted (block 312); otherwise, Full is deasserted (block 314). Similar comparisons are performed to determine whether to assert or deassert the Nearly Full and Nearly Empty signals (blocks 316 and 318).

As shown in FIG. 3, the ReadAndDecrement operation 400 can be implemented in a similar manner, except that here the initial determination that is made is whether the count already equals its minimum value (i.e., a “Yes” exit at block 404), in which case the count is decremented no further.

It will be appreciated that the processes shown in FIGS. 2 and 3 can be varied in many respects. For example, certain blocks could be combined, separated, and/or eliminated, and/or the order of the blocks could be varied. For example, in a software implementation, if it were determined that the count equaled its maximum or minimum value, it would not be necessary to perform further comparisons against the high and low watermarks in order to set the Nearly Empty and Nearly Full signals properly.

In one embodiment, at least part of the processes shown in FIGS. 2 and 3 are implemented in hardware. A hardware implementation can be advantageous because it enables each operation to be performed atomically, since the hardware clock will often be much faster than the software instruction cycle, thereby ensuring that an entire ReadAndIncrement or ReadAndDecrement operation can be performed in a single instruction cycle. It should be appreciated, however, that the operations shown in FIGS. 2 and 3 can be implemented in any suitable manner.

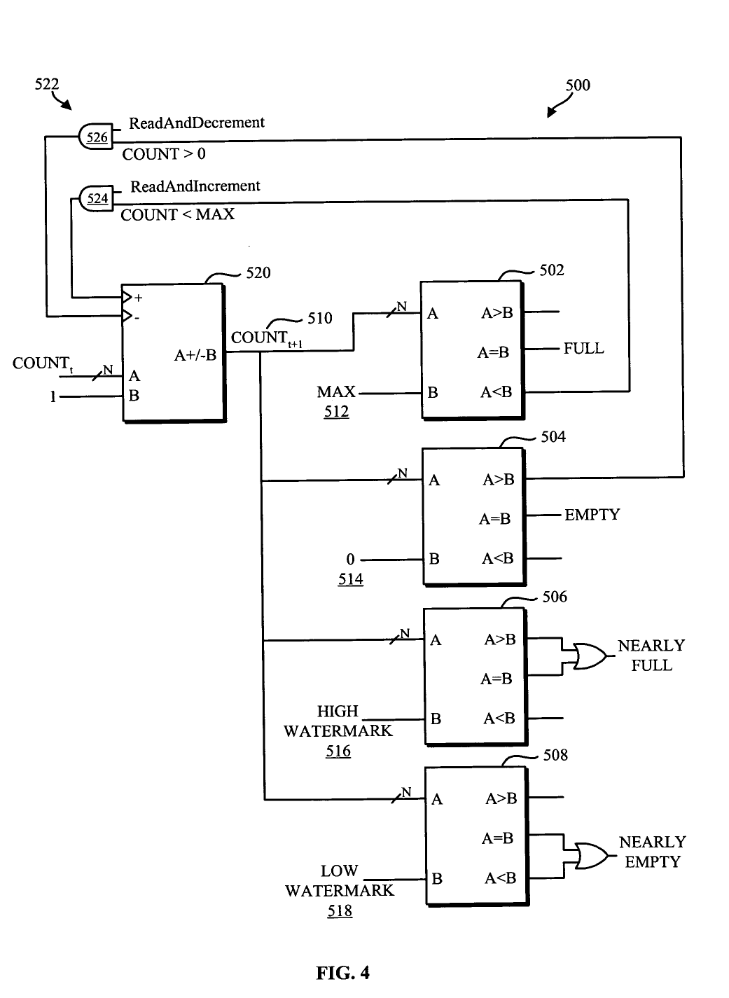

FIG. 4 is a high-level illustration of one possible implementation 500 of the operations shown in FIGS. 2 and 3. Referring to FIG. 4, comparators 502, 504, 506, and 508 are used to generate the status signals (Full, Empty, Nearly Full, Nearly Empty) by comparing the value of the N-bit count 510 with each of the configuration values 512, 514, 516, 518. An adder/subtractor circuit 520 is used to increment and decrement the count, and appropriate conditioning logic 522 is used to ensure that the count is incremented only when the ReadAndIncrement signal is asserted and the value of the count is less than its maximum (gate 524) and that the count is decremented only when the ReadAndDecrement signal is asserted and the count is greater than zero (gate 526).

It should be appreciated that the functionality shown in FIG. 4 could be implemented in any suitable manner. For example, those of skill in the art will appreciate that the functionality that is conceptually illustrated in FIG. 4 could be readily implemented using circuitry that was optimized to conserve space, to execute more rapidly, and/or the like. In other embodiments, some or all of the functionality shown in FIG. 4 could be implemented in software, which, when executed by a processor, would cause the processor to perform the operations shown in FIGS. 2 and 3. For example, the initial comparison and increment/decrement blocks 304, 306, 404, and 406 could be performed by software operating with general-purpose hardware support, while the generation of the status signals could be performed by circuitry functionally similar to the comparator array 502, 504, 506, 508 shown in FIG. 4. Thus, it should be understood that FIG. 4 is provided merely for purposes of illustration, not limitation.

The counting semaphores described above can be quite useful for implementing software FIFOs in network processing engines. NPEs typically contain hardware support for only a limited number of FIFOs. Although additional FIFOs could be implemented in software, there are problems with this approach.

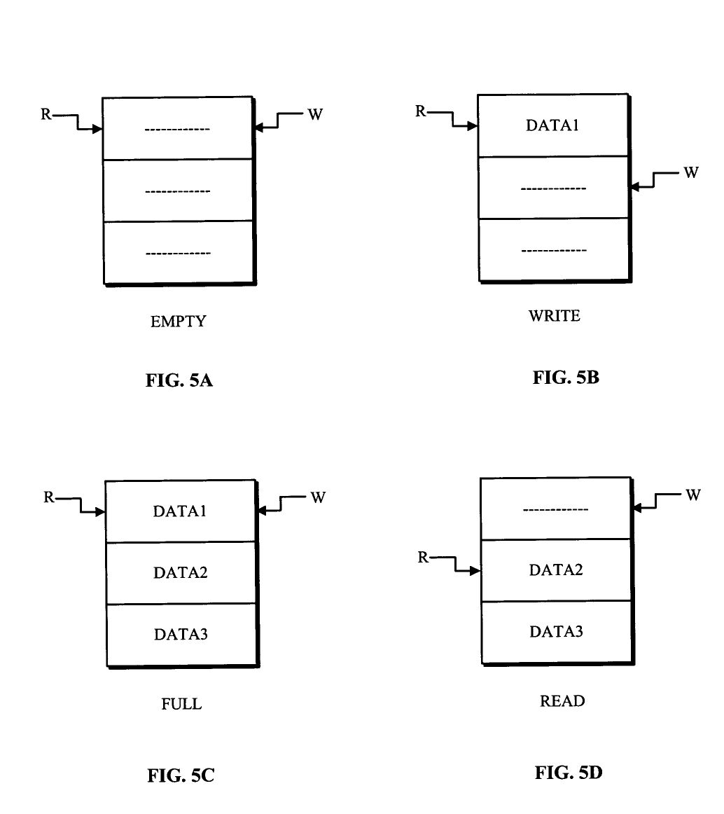

For example, a FIFO typically has a separate “writer” (e.g., a context that writes data into the FIFO) and a “reader” (e.g., a context that reads data from the FIFO). As shown in FIGS. 5A-5D, to operate a software FIFO, the software typically must maintain, at a minimum, a read pointer and a write pointer. As data is written into an empty FIFO, such as that shown in FIG. 5A, the write pointer is updated to point to the next available space for writing new data, as shown in FIG. 5B. Similarly, as data is read from a FIFO, the read pointer is updated to point to the next piece of data to be read (as shown in FIGS. 5C and 5D). Because the pointers wrap-around once they reach the end of the FIFO, the condition where the read and write pointers are equal can signify either that the FIFO is empty (FIG. 5A) or that it is full (FIG. 5C).

A counting semaphore can be used to maintain a FIFO count for a software FIFO by providing the ability to atomically increment and decrement the count. It is also very useful for the reader and writer to be able to ascertain the empty/full status of a FIFO, since the reader typically must check whether the FIFO is empty before reading from it, and the writer typically must check whether the FIFO is full before writing to it. Without an explicit count, the reader and writer will generally need to compare the read and write pointers to determine the empty/full status, and this comparison typically requires several cycles of execution time at a minimum, and thus can tangibly degrade overall data throughput. Moreover, additional processing is generally needed to determine whether the FIFO is full or empty when the read and write pointers are equal, resulting in further performance degradation.

The counting semaphores can be used to solve some or all of the problems described above. In addition to enabling the maintenance of an atomic FIFO count, counting semaphores can provide convenient status and signaling capability, which is otherwise typically infeasible in a software-only FIFO implementation. In some embodiments, the reader and writer contexts can read and/or test the semaphore status for the Empty, Nearly Empty, Nearly Full, and Full conditions. These conditions could also be used for signaling the reader and writer contexts. For example, the FIFO reader could use the Full condition as a signal to read the FIFO, and the FIFO writer could use the Empty condition as a signal to write more data.

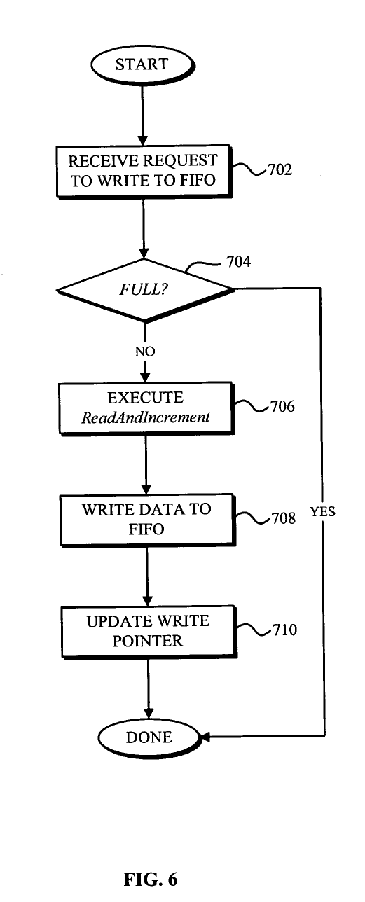

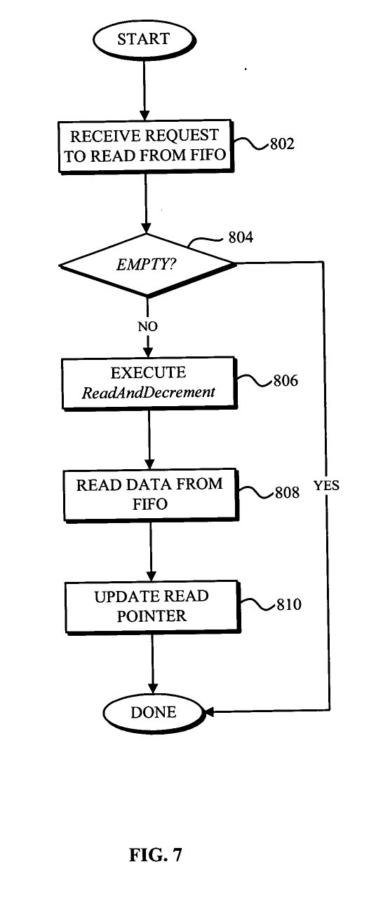

FIGS. 6 and 7 illustrate the use of counting semaphores to control access to a FIFO. As shown in FIG. 6, upon receiving a request to write data to the FIFO (block 702), a check is performed to determine whether the FIFO is full (block 704). If the FIFO is full (i.e., a “Yes” exit at block 704), then the data is not written to the FIFO. Depending on the application, the data (e.g., a packet) could simply be discarded, or the process that requested permission to write the data could wait until the FIFO was no longer full and then proceed with writing the data.

Referring once again to FIG. 6, if the FIFO is not full (i.e., a “No” exit at block 704), then a ReadAndIncrement operation is performed to update the value of the count and the status flags (block 706). The data is then written into the FIFO (block 708), and the write pointer is updated to point to the next available storage space in the FIFO (block 710).

As shown in FIG. 7, a similar process can be used to read data from the FIFO. Namely, upon receiving a request to read data from the FIFO (block 802), a check can be performed to determine whether the FIFO is empty (block 804). If the FIFO is empty, then no data is read from the FIFO. The process that wished to read from the FIFO could simply proceed, or it could wait until some data was written into the FIFO. As shown in FIG. 7, if the FIFO contains valid data (i.e., a “No” exit at block 804), then a ReadAndDecrement operation is performed to update the value of the count and the status flags (block 806). The data is then read from the FIFO (block 808), and the read pointer is updated to point to the next item of data to be read (block 810).

It will be appreciated that FIGS. 6 and 7 are provided merely for purposes of illustration and not limitation. For example, the order of the blocks could be varied. For example, the ReadAndIncrement block could be performed after data was written to the FIFO, and/or the ReadAndDecrement block could be performed after data was read from the FIFO. Alternatively, the ReadAndIncrement and ReadAndDecrement blocks could be performed before the FIFO's empty/full status is tested, and/or those tests could be subsumed within the ReadAndIncrement and ReadAndDecrement operations themselves.

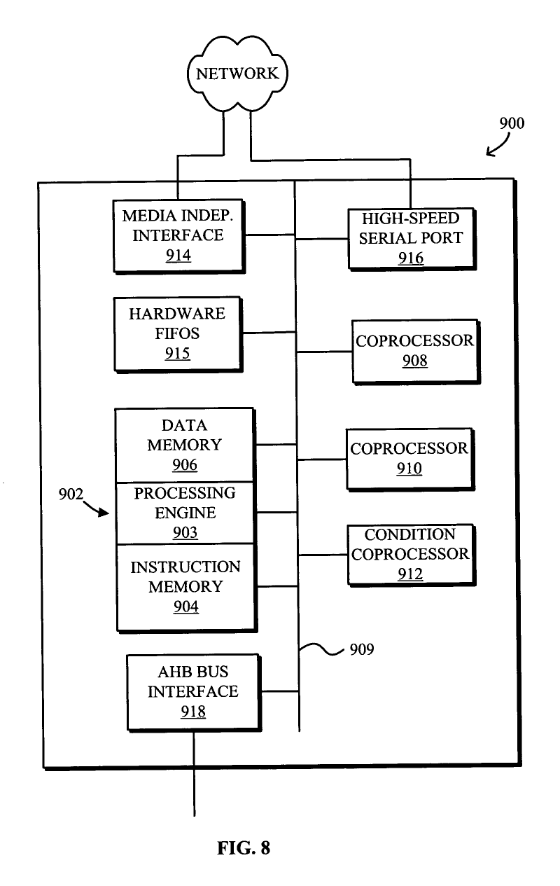

FIG. 8 illustrates a system, such as a network processing engine 900, suitable for practicing the various embodiments described herein. Network processing engine 900 may include a processor core 902 used to accelerate the functions performed by a larger network processor that contains several such network processing engines. For example, network processing engine 900 may include functionality similar to that found in the network processing engines contained in the IXP425 network processor produced by Intel Corporation.

As shown in FIG. 8, processor core 902 may, for example, comprise a multi-threaded RISC engine 903 that has a self-contained instruction memory 904 and data memory 906 to enable rapid access to locally stored code and data. Processor core 902 may, for example, be specially adapted for packet processing. Network processing engine 900 may also include one or more hardware-based coprocessors 908, 910, 912 for performing one or more specialized functions-such as serialization, cyclic redundancy checking (CRC), cryptography, HDLC bit stuffing, and/or the like-that are relatively difficult to implement using core processor 902. For example, as previously indicated, a condition coprocessor 912 may be provided that contains, among other features, a set of mutex semaphores. In addition, network processing engine 900 may include hardware support 915 for a set of FIFOs.

Network processing engine 900 will also typically include one or more interfaces 914, 916, 918 for communicating with other devices and/or networks. For example, network processing engine 900 may include an AHB bus interface 918 for communicating with a larger network processing chip, one or more high-speed serial ports 916 for communicating using serial bit stream protocols such as T1 and E1, one or more Media Independent Interfaces 914 for interfacing with, e.g., Ethernet networks, and/or the like. One or more internal buses 909 are also provided to facilitate communication between the various components of the system.

Network processing engine 900 also includes hardware and/or software for implementing the counting semaphore functionality described above. For example, the processes shown in FIGS. 2 and 3, and/or the circuitry shown in FIG. 4 or its equivalent, could be implemented as part of processor 902, as part of condition coprocessor 912, as part of one of the other coprocessors 908, 910, as a separate circuit containing dedicated logic, or as some combination thereof.

One of ordinary skill in the art will appreciate that the systems and methods described herein can be practiced with devices and architectures that lack many of the components and features shown in FIG. 8 and/or that have other components or features that are not shown. For example, some systems may include different interface circuitry, a different configuration of memory, and/or a different set of coprocessors. Alternatively, or in addition, some systems may not include FIFO hardware support 915, replacing it instead with the FIFO support described above. Moreover, although FIG. 8 shows a network processing engine implemented on a single chip, in other embodiments some or all of the functionality shown in FIG. 8 could be distributed amongst multiple chips. Thus, it should be appreciated that FIG. 8 is provided for purposes of illustration and not limitation.

While various embodiments are described and illustrated herein, it will be appreciated that they are merely illustrative, and that modifications can be made to these embodiments. Thus, the concepts and methodologies presented herein are intended to be defined only in terms of the following claims.

1. A method for implementing a software FIFO in a network processing engine, the method comprising:
receiving a request to write data to a FIFO;
determining whether the FIFO is full by comparing the value of a counting semaphore with a predefined maximum value; and
if the value of the counting semaphore is less than the predefined maximum value:
incrementing the counting semaphore; and
writing data to the FIFO.

2. The method of claim 1, further comprising:
receiving a request to read data from the FIFO;
reading the data from the FIFO; and
decrementing the counting semaphore.

3. The method of claim 2, in which the method is performed in the order recited.

4. The method of claim 1, further comprising:
receiving a request to read data from the FIFO;
determining whether the FIFO is empty by comparing the value of the counting semaphore with a predefined minimum value; and
if the value of the counting semaphore is greater than the predefined minimum value:
reading data from the FIFO; and
decrementing the counting semaphore.

5. The method of claim 4, in which at least said incrementing and decrementing are atomic.

6. The method of claim 1, further comprising:
if the value of the counting semaphore is not less than the predefined maximum value:
discarding the data that was to be written to the FIFO.

7. The method of claim 1, further comprising:
if the value of the counting semaphore is not less than the predefined maximum value:
blocking further execution of a process that made the request to write data to the FIFO until the value of the counting semaphore is less than the predefined maximum value.

8. The method of claim 1, in which the counting semaphore is implemented using special-purpose hardware.

9. The method of claim 8, in which the special-purpose hardware comprises a counter.

10. The method of claim 9, in which the special-purpose hardware further comprises at least one comparator for comparing an output of the counter with a predefined value and generating one or more signals based on the comparison.

11. A computer program product embodied on a computer readable medium, the computer program product comprising instructions which, when executed by a processor, are operable to perform actions comprising:
receiving a request to write data to a FIFO;
determining whether the FIFO is full by comparing the value of a counting semaphore with a predefined maximum value; and
if the value of the counting semaphore is less than the predefined maximum value:
incrementing the counting semaphore; and
writing data to the FIFO.

12. The computer program product of claim 11, further comprising instructions which, when executed by the processor, are operable to perform actions comprising:
receiving a request to read data from the FIFO;
reading the data from the FIFO; and
decrementing the counting semaphore.

13. A network processing engine comprising:
one or more coprocessors;
a memory;
a counting semaphore;
signal generation logic for signaling the status of a FIFO; and
computer code stored in said memory, which, when executed by one or more of said coprocessors, is operable to implement a FIFO using said counting semaphore and said signal generation logic.

14. A network processing engine as in claim 13, in which said signal generation logic is operable to generate a signal indicating whether or not the FIFO is full.

15. A network processing engine as in claim 13, in which said signal generation logic is operable to generate a signal indicating whether or not the FIFO is empty.

16. A network processing engine as in claim 13, in which said signal generation logic is operable to generate a signal indicating whether or not the FIFO contains more than a first predefined amount of data.

17. A network processing engine as in claim 16, in which said signal generation logic is further operable to generate a signal indicating whether or not the FIFO contains less than a second predefined amount of data.

18. A network processing engine as in claim 16, in which said first predefined amount comprises a number having the same number of bits as a maximum value of the counting semaphore.

19. A network processing engine as in claim 13, in which the signal generation logic comprises one or more comparators.

20. A network processing engine as in claim 13, in which the signal generation logic and the counting semaphore are implemented as part of the same circuit, the circuit comprising:
an adder/subtractor;
one or more comparators operatively connected to an output of the adder/subtractor; and
conditioning logic operatively connected to an output of the one or more comparators and an input of the adder/subtractor, the conditioning logic being operable to signal the adder/subtractor to increment or to decrement a value of the counting semaphore.

21. A network processing engine as in claim 13, in which the counting semaphore comprises a counter.

22. A network processing engine as in claim 21, in which the signal generation logic comprises at least one comparator for comparing an output of the counter with a predefined value and generating one or more signals based on the comparison.

23. A signaling method performed by a network processing engine, the method comprising:
maintaining a counting semaphore, the counting semaphore being operable to increment and decrement a count in an atomic fashion;
atomically incrementing the value of the count in response to a first action by a first process; and
taking at least one action in a second process based on the incremented value of the count.

24. The signaling method of claim 23, further comprising:
maintaining a plurality of signals derived from the count, the signals being modified in an atomic fashion.

25. The signaling method of claim 24, in which the count corresponds to an amount of data contained in a predefined portion of memory.

26. The signaling method of claim 24, further comprising:
atomically changing a state of a first of said signals in response to atomically incrementing the value of the count; and
taking at least one action based on the changed state of the first of said signals.

27. The signaling method of claim 25, in which the plurality of signals comprise an indication of whether the predefined portion of memory is full and an indication of whether the predefined portion of memory is empty.

28. The signaling method of claim 23, in which the counting semaphore is implemented using special-purpose hardware.

29. The signaling method of claim 28, in which the special-purpose hardware comprises a counter.

30. The signaling method of claim 29, in which the special-purpose hardware further comprises at least one comparator for comparing the count with a predefined value and generating one or more signals based on the comparison.
